(19) United States
(12) Patent Application Publication
(10) Pub. No.: US 2015/0270737 A1
(43) Pub. Date: Sep. 24, 2015

(54) TERMINAL DEVICE COVER AND A TERMINAL DEVICE FOR CONTACTLESS CHARGING

(71) Applicant: Sony Corporation, Tokyo (JP)

(72) Inventor: Hiroshi SHIRAKAWA, Tokyo (JP)

(73) Assignee: Sony Corporation, Tokyo (JP)

(21) Appl. No.: 14/222,145

(22) Filed: Mar. 21, 2014

(51) Int. Cl. H02J 7/02; H02J 7/00

(52) U.S. Cl. CPC H02J 7/025; H02J 7/0042

(57) ABSTRACT

A terminal device cover having a front surface part, a lateral surface part, and a rear surface part. The terminal device cover is arranged so as to accommodate a terminal device. The front surface part, lateral surface part, and rear surface part of the cover are respectively arranged to cover a front surface, lateral surface, and rear surface of a terminal device. Circuitry configured to receive wireless electrical energy transmission is arranged in the front surface part of the terminal device cover. This circuitry includes a power receiving circuit, a rectifier circuit, and a charging output terminal. The power receiving section is adapted to receive electrical power transmitted from a non-contact power transmission device. The rectifier circuit rectifies the received power, and the charging output terminal is connects to a terminal device charging terminal in order to transfer electrical power to the terminal device.

### BACKGROUND

1. Technical Field

The present disclosure relates to a cover for contactless charging of a terminal device such as a mobile phone, smart phone, a tablet device, or the like.

2. Description of the Related Art

In recent years, the technology for contactless electrical energy transfer has attracted attention in the area of terminal devices, such as smart phones and tablet devices. This technology is sometimes referred to as wireless power, wireless energy transmission, contactless energy transfer, wireless charging, etc. Exemplary methods of contactless power transfer include: electromagnetic induction, resonant magnetic induction, etc.

In an electromagnetic induction type apparatus for contactless power transfer, both the power transmission side of the apparatus and the power receiver side of the apparatus have coils. Through the mutual inductive coupling between these two coils, changes in the current of the power transmission coil induces a voltage in the power receiver coil, with the result being that electrical power is transferred to the receiver coil without requiring physical contact.

In the resonant magnetic induction type apparatus for contactless energy transfer, the coils in both the power transmission side of the apparatus and the power receiver side of the apparatus are part of resonant LC circuits, which are tuned to the same resonant frequency. When the magnetic field is resonant with the LC circuits, electrical power is transmitted without contact from the power transmission side to the power receiver side.

### SUMMARY

In a conventional terminal device, the power receiving coil for contactless power transfer is collocated with device's communications antenna on the back side of the device. For example, the antenna and circuitry for near field communication (NFC), cellular communication, Wi-Fi, Bluetooth™, etc. are in many cases arranged on the back side of the terminal device. The close proximity of the power reception coil and the communication antenna is mutually detrimental to both the power reception coil and the communication antenna. The presence of the coil decreases the sensitivity of the wireless communications antenna, and the presence of the wireless communications antenna decreases the efficiency of the contactless energy transfer.

By designing an arrangement wherein the antenna and coil are well separated one can overcome the problems with poor communication sensitivity and low efficiency energy transfer. This design can be achieved by incorporating the contactless power reception coil and circuitry into the cover of the terminal device.

In one embodiment, the present disclosure provides a terminal device cover having a front surface part, a lateral surface part, and a rear surface part. The terminal device cover is arranged so as to accommodate a terminal device. The front surface part is arranged to cover a front surface of a terminal device. The lateral surface part is formed continuously from the front surface part and is arranged to cover a lateral surface of a terminal device. The rear surface part is formed continuously from the lateral surface part and is arranged in a position to come into contact with a rear surface of the terminal device. Circuitry configured to receive wireless electrical energy transmission is arranged in the front surface part of the terminal device cover. This circuitry includes a power receiving section, a rectifier circuit, and a charging output terminal. The power receiving section is adapted to receive electrical power transmitted from a non-contact power transmission device. The rectifier circuit is adapted to rectify the electrical power received by the power receiving section. The charging output terminal is arranged on the terminal device cover and is adapted for connecting to a charging terminal of the terminal device in order to transfer electrical power to the terminal device.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a front view showing the external appearance and structure of a terminal device, a terminal device cover, and a power feeding device, according to certain embodiments;

FIG. 2A is a front view of a terminal device cover, according to certain embodiments;

FIG. 2B is a perspective view of a terminal device showing the front, upper, and left-side surfaces, according to certain embodiments;

FIG. 3 is a block diagram showing an example of the interrelations among the power receiving coil, rectifier circuit, charging output terminal, and controller in the terminal device cover, according to certain embodiments;

FIG. 4 is a block diagram showing the internal structure of a terminal device, according to certain embodiments;

FIG. 5A is a perspective view of a terminal device cover with a terminal device accommodated within the terminal device cover, where the terminal device is being charged and the terminal device cover is closed, according to certain embodiments;

FIG. 5B is a perspective view of a terminal device cover with a terminal device accommodated within the terminal device cover, where the terminal device is being charged and the terminal device cover is open, according to certain embodiments;

FIG. 6A is a back view of a terminal device, where the charge terminal has been provided on the back of the terminal device, according to certain embodiments;

FIG. 6B is a front view of a terminal device cover, where the charging output terminal has been provided on the rear surface part of the terminal device cover and is arranged in order to accommodate a terminal device, and where the charge terminal has been provided on the back of the terminal device, according to certain embodiments;

FIG. 7A is a perspective view of a terminal device, where the charge terminal is a Universal Serial Bus (USB) connector, according to certain embodiments;

FIG. 7B is a front view of a terminal device cover, where the charging output terminal is a USB plug, according to certain embodiments;

FIG. 8 is a front view of a terminal device, a terminal device cover, and a power feeding, where a magnetic sensor in the terminal device detects when the front surface of the terminal device cover is closed over the front surface of the terminal device, according to certain embodiments;

FIG. 9A is a perspective view of a terminal device in which the rear surface portion of the terminal device is replaced by accommodating the terminal device in a terminal device cover such that the terminal device cover becomes integral to the terminal device, according to certain embodiments; and

FIG. 9B is front view of a terminal device accommodated in a terminal device cover such that the terminal device cover becomes integral to the terminal device, according to certain embodiments.

### DETAILED DESCRIPTION

Referring now to the drawings, wherein like reference numerals designate identical or corresponding parts throughout the several views.

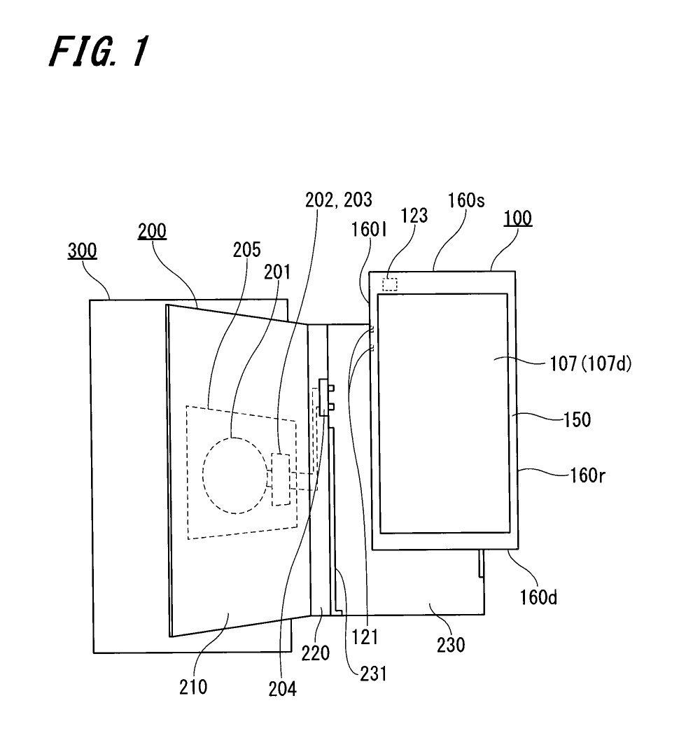

Referring first to FIG. 1, FIG. 1 illustrates a non-limiting example of a terminal device 100 arranged with a terminal device cover 200 and a charging device 300. FIG. 1 is a front view which shows the external structural appearance of the terminal device 100 arranged with respect to the terminal device cover 200 and the charging device 300. The charging device 300 performs contactless energy transfer with respect to the cover 200. The charging device can be formed in a pad shape, and a coil for power transmission may be incorporated in the inside of the charging device 300.

The touch panel 107 is provided in the front face portion of the terminal device 100. The touch panel 107 includes a touch sensor and a display 107d which may be either laminated or integrally formed in the touch panel 107. The display 107d displays a character, an image, a moving object, etc. on a display screen and the display 107d includes a liquid crystal display (LCD), an organic electro luminescence (EL) panel, etc. The proximity sensor 123, which may detect a proximity of a door part of the cover 100 (i.e. the front surface part 210 discussed later), is provided in the upper-left quadrant of the touch panel 107.

In the following description, the terminal device has a front part 150, on which the touch panel 107 is provided to the front surface portion of 150, and the terminal device has a rear surface portion (not shown) with a surface facing opposite the front portion 150. Moreover, the side portion 160 of the terminal device 100 includes four surfaces, which form the side surfaces of the terminal device 100. These four surfaces, which are shown in FIG. 1, include: the upper-surface portion 160s, the bottom-surface portion 160d, the left-side portion 160l, and the right-side portion 160r. The charge terminal 121 is provided in the left-side portion 160l of the terminal device 100. When the terminal device 100 is accommodated in the terminal device cover 200, the charge terminal 121 is electrically contacted to the charging output terminal 204, which is discussed later.

The cover 200 includes the front part 210 arranged in the position facing the front surface portion 150 of the terminal device 100, the side part 220 arranged in the position facing the left-side portion 160l of the terminal device 100, and the rear surface part 230 arranged in the position facing the rear surface portion of the terminal device 100. The front surface part 210 of the cover 200 is constructed with two surfaces (i.e. a first surface and a second surface). The first surface of the front surface part 210 is defined as the surface which is in closer proximity to the back surface part 230 of the cover 200 when the cover is in the closed position (i.e. when the front surface part 210 is closed in order to cover the front surface portion 150 of a terminal device 100 accommodated in the cover 200).

The first surface of the front part 210 and the second surface of the front part 210 may be made from non-metallic materials such as cloth, leather, and of synthetic resin made from an adhesive agent, and the first surface and second surface of the front part 210 may be bonded together by methods such as adhesion, stitching, etc.

The power receiving coil 201, the controller 202, and the rectifier circuit 203 are arranged between the first surface of the front part 210 and the second surface of the front part 210. The power receiving coil 201 receives electric power transmitted for the electric power feeding device 300, and the rectifier circuit 202 and control circuit 203 are arranged to rectify the received electric power.

A magnetic sheet 205 is arranged between the first surface of the front part 210 of the cover 200 and the power receiving coil 201, the controller 202, and the rectifier circuit 203. Moreover, the magnetic sheet 205 covers the area encompassed by power receiving coil 201, the controller 202, and the rectifier circuit 203, such that the magnetic sheet 205 shields the power receiving circuitry from the terminal device 100 accommodated in the cover 200. That is to say that when the terminal device 100 is accommodated in the cover 200 and the cover 200 is closed the magnetic sheet 205 is disposed between the touch panel display 107d and the power receiving coil 201, the controller 202, and the rectifier circuit 203.

In the embodiment shown in FIG. 1 the magnetic sheet 205 is shown to cover the area encompassed by the power receiving coil 201, the controller 202, and the rectifier circuit 203. In an alternative embodiment the magnetic sheet 205 has a smaller area such that it covers the area encompassed by the power receiving coil 201, but does not necessarily cover the area of the controller 202 and the rectifier circuit 203. The magnetic sheet 205 is formed as a sheet containing magnetic materials, such as a ferrite material. The magnetic sheet performs the functions of (1) suppressing noise from the transparent electrodes (not shown) of the display 107d and (2) improving the efficiency of the contactless energy transfer. The efficiency of the contactless energy transfer is improved by the magnetic sheet 205 due to increasing the coupling into the power receiving coil 201 of magnetic flux generated by the power transmission coil (not shown).

The charge output terminal 204 is provided in the rear-surface portion 230 of the cover 200. The charge output terminal 204 can be a spring type connector or some other type of electrical connector. The electric power to the charge output terminal 204 is supplied by the rectifier circuit 202 in the front surface part 210 of the cover 200. The charge output terminal 204 is arranged longitudinally along the rear surface part 230 of the cover 200 such that the position of the charge output terminal 204 corresponds to the position of the charge terminal 121 provided on the left-side portion 160l of the terminal device 100. Moreover, the terminal device fixing part 231 is arranged on the rear surface part 230 of the cover 200 as a wall part to house the terminal device 100. The terminal device fixing part 231 forms a substantially right angle with respect to the rear surface part 230 of the cover 200. The position of the terminal device fixing part 231 is arranged such that when the terminal device 100 is fixed to the cover 200, the terminal device fixing part 231 contacts a predetermined area along the side portion 160 of terminal device 100. Thereby, the terminal device fixing part 231 determines the position of the terminal device within the cover 200 such that the charge output terminal 204 and the charge terminal 121 are fixed in position to establish electrical contact between the charge output terminal 204 and the charge terminal 121.

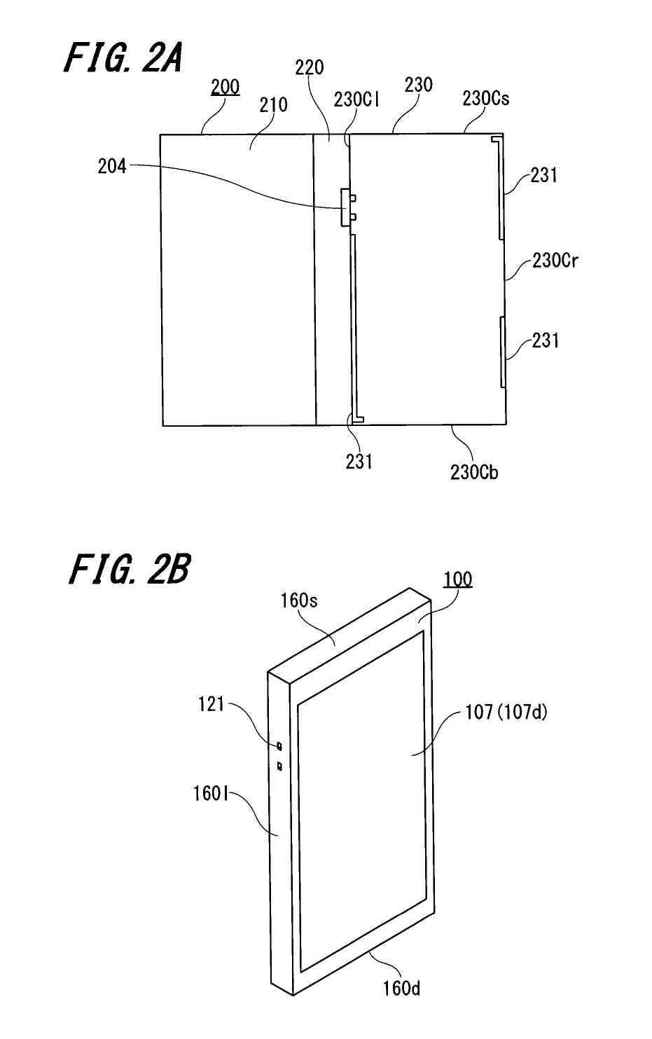

FIGS. 2A and 2B show the appearance of the external structural of the cover 200 and the terminal device 100. FIG. 2A is a front view of the cover showing the state of opening the cover 200. FIG. 2B is a perspective view of the terminal device 100 showing a side view looking towards the left-side portion 160l of the terminal device 100. In FIG. 2A, an exemplary non-limiting embodiment of the terminal device 100 is shown where the device fixing part 231 is provided in three positions on the outer periphery of the rear surface part 230 of the cover 200. These three positions include one position on the left-outer edge part 230Cl of the rear surface part 230, and two positions on the right-outer edge part 230Cr of the rear surface part 230. The device fixing part 231 is attached along edge 230Cl and extends from a position immediately below the charge output terminal 204 to the base-outer edge part 230Cb of the rear surface part 230. Along the 230Cr edge the device fixing part 231 is attached to two sections. The first section of the device fixing part 231 positioned along the edge 230Cr extends from the upper-outer edge part 230Cs along one third of the length of the edge 230Cr. The second section of the device fixing part 231 positioned along the edge 230Cr occupies a predetermined area near the base-outer edge part 230Cb of the rear surface part 230. Other embodiments with different arrangements of the device fixing part 231 are possible so long as the device fixing part 231 favorably positions the terminal device 100 with respect to the rear surface part 230, and the output terminal 204 is positioned for favorable electrical contact with the charge terminal.

In the embodiment shown in FIG. 2B the charge terminal 121 of the terminal device 100 is provided in the left-side portion 160l, and the position of the charge output terminal 204 in the cover 200 is in a corresponding position on the left-outer edge part 230Cl of the rear surface part 230 of the cover 200.

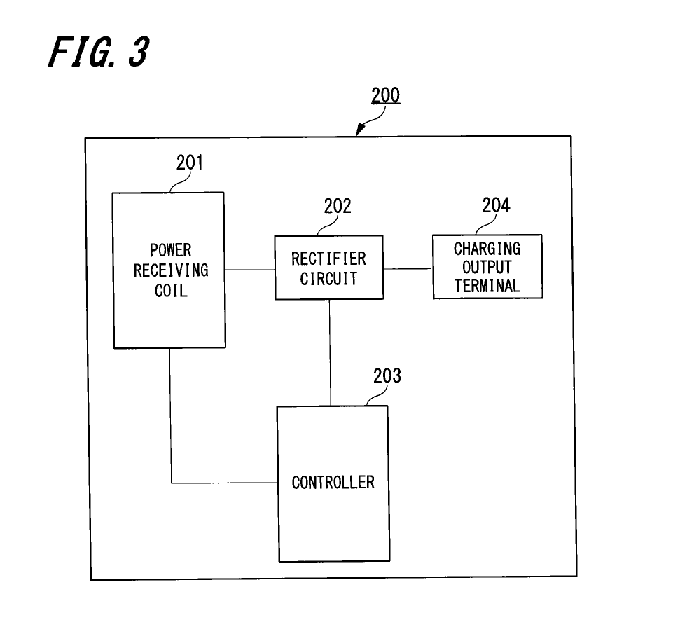

FIG. 3 is a block diagram of the cover 200, showing the functional relations among the power receiving coil 201, rectifier circuit 202, controller 203, and charging output terminal 204. The power receiving coil 201, rectifier circuit 202, controller 203, and charging output terminal 204 are provided in the cover 200. The power receiving coil 201 receives the electric power transmitted from the charging device 300. This electric power is transmitted via the magnetic flux generated by the power transmission coils of the charging device 300 (refer to FIG. 1). The rectifier circuit 202 rectifies the alternating-current power received by the power receiving coil 201 generating direct-current power. The control circuit 203 controls the voltage and electric current of the direct-current power from the rectifier circuit 202. The charge terminal 121 of terminal device 100 is electrically connected to the charging output terminal 204, and the direct-current power is conducted through the charging output terminal 204, through charge terminal 121 into the terminal device 100, where the direct-current power charges a secondary battery (not shown) in the terminal device 100.

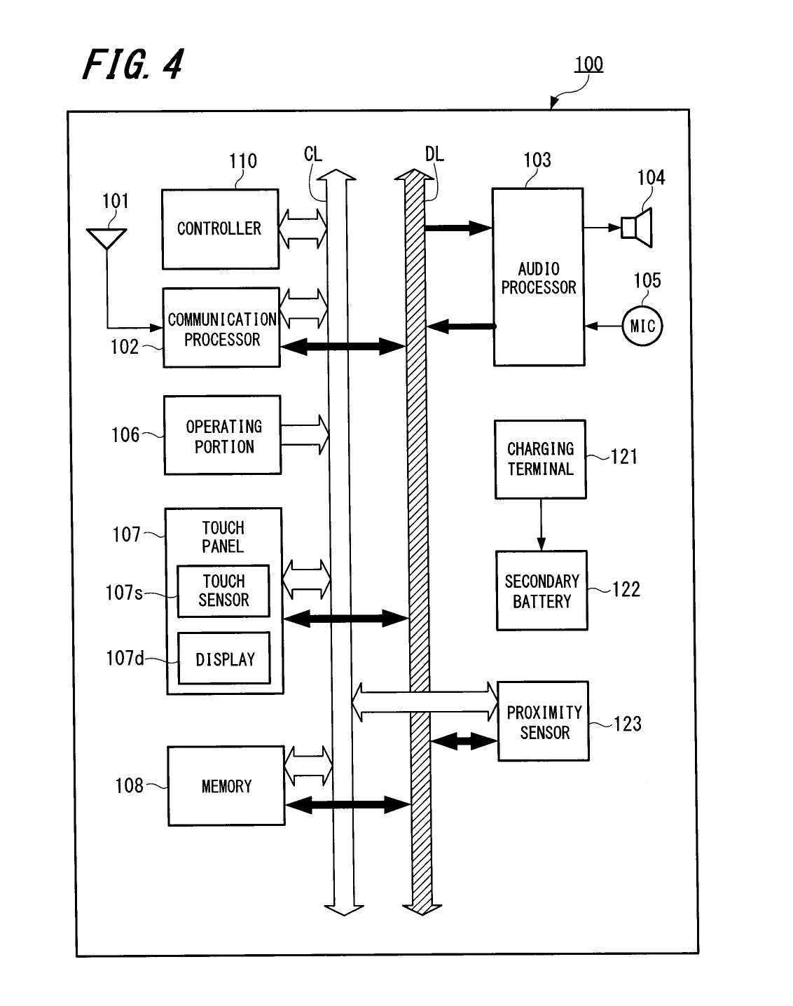

FIG. 4 is a block diagram showing an example of the internal structure of a mobile phone terminal device. The terminal device 100 is provided with a communication processor 102 connected to an antenna 101, an audio processor 103, a speaker 104, and a microphone 105. The antenna 101 communicates using wireless signals with mobile phone base stations. The communication processor 102 controls the wireless communications between the antenna 101 and the base stations. The audio processor 103 encodes the voice signals from the microphone 105 according to a predetermined transmission format. The audio processor 103 supplies the encoded voice data to the communication processor 102 via the data line (DL). The speaker 104 converts into sound the voice data supplied from the audio processor 102. The microphone 105 picks up the surrounding sounds and converts the detected sounds into an audio signal, and the microphone 105 transmits the audio signal to the audio processor 103.

Additionally, the terminal device 100 is provided with an operating portion 106, touch panel 107, memory 108, the charge terminal 121, secondary battery 122, and the proximity sensor 123. The touch panel 107 includes the display 107d and the touch sensor 107s. In the touch sensor 107s, an electrode pattern is formed on a printed circuit board or a transparent film. The touch sensor 107s coordinates and senses values, such as the electrostatic capacitance value in each electrode pattern, and outputs the electrode pattern values to the controller 110 via the data line DL. The charge terminal 121 includes an electrically conducting material which is in electrical contact with the electrically conducting material of the charge output terminal 204 of the cover 200. This electrical connection provides an electrical path to the secondary battery 122. The secondary battery 122 stores the electrical power input from the charge terminal 121, and the secondary battery 122 includes a charging battery, such as a lithium ion battery.

The proximity sensor 123 detects the presence of adjoining objects without requiring actual contact with the objects. The proximity sensor 123 can be used to change aspects of the terminal device 100 operation. For example, proximity sensor 123 may cause the screen light of the display part 107 to extinguish during a telephone call when the terminal device is in proximity to an object such as an ear. In certain embodiments, the proximity sensor could use scattered infrared light as a proximity sensor. However, other types of proximity sensors can be used including: induction type proximity sensors, capacitance type proximity sensors, ultrasonic type proximity sensors, electromagnetic waveform type proximity sensors, etc.

The controller 110 includes a central processing unit (CPU) and performs communication control, audio processing, various signal processing functions, and control of the each part of the terminal device 100. Moreover, the controller 110 extinguishes the screen light of the display 107d when the proximity sensor 123 detects that the front part 210 of the cover 200 is in proximity to the proximity sensor 123. Also, a scanning operation may be stopped based on inputs from the proximity sensor 123, where the scanning operation is for detecting changes of the electrostatic capacitance value arising from each electrode patter of the touch sensor 107s.

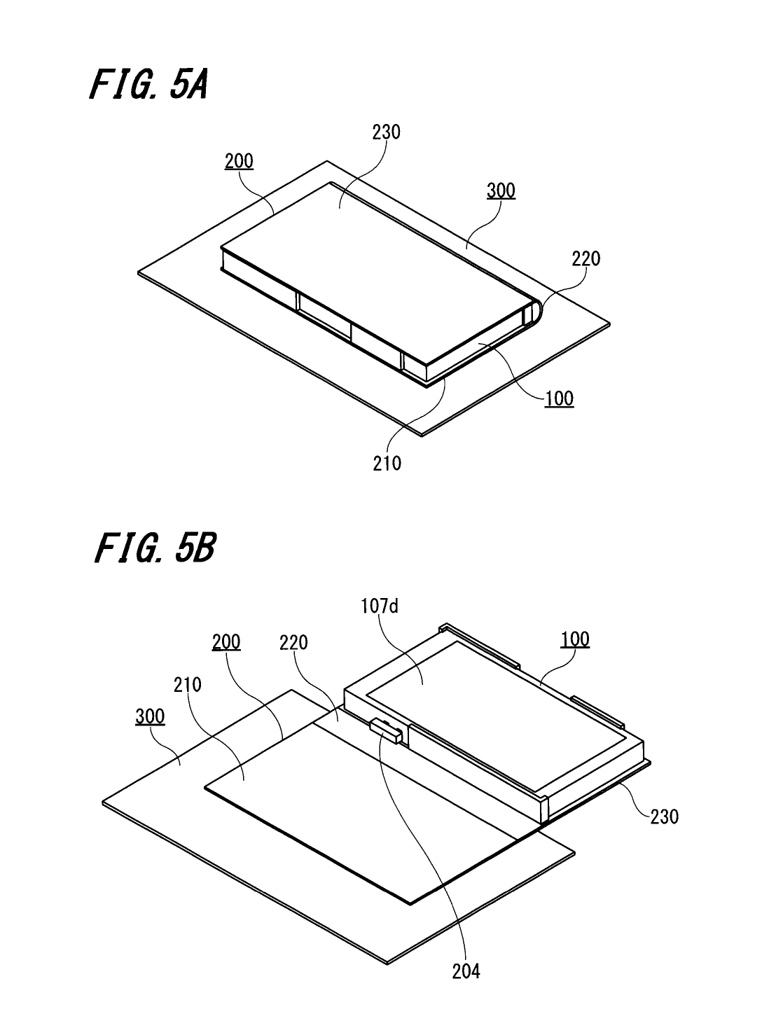

FIGS. 5A and 5B show examples of the charging method when the terminal device 100 is accommodated in the cover 200. Two exemplary charging methods are shown.

In FIG. 5A, the charging method is shown wherein the cover 200 is closed, i.e. the closed state of the cover 200 is where the front part 210 of the cover 200 is arranged on the front part 150 of the terminal device 100. In the closed charging configuration, the front part 210 of the cover 200 is turned down on the charging device 300 such that the front part 210 of the cover 200 is arranged close to the charging device 300.

By closing the cover 200, the power receiving coil 201 and the display 107d are in close physical proximity. This close proximity could increase the coupling of noise between the power receiving coil 201 and the display 107d. However, as shown in FIG. 1, when the cover 200 is in the closed position, the magnetic sheet 205 is between the power receiving coil 201 and the display 107d. Thus, the magnetic sheet 205 shields the power receiving coil 201 from noise emitted from the display 107d significantly attenuating noise affecting the power receiving coil 201. Moreover, the radiation efficiency of the magnetic flux generated between the power receiving coil 201 and the power transmission coil (not shown) in the charging device 300 is also improved by the magnetic sheet 205 being arranged next to the power receiving coil 201. Therefore, the contactless energy transfer efficiency is improved by the arrangement of the magnetic sheet 205 in the front surface part 210.

In one embodiment, the proximity sensor 123 is arranged on the front part 150 of the terminal device 100 and detects the proximity of the front part 210 of the cover 200. When proximity sensor 123 detects the proximity of the front part 210, the proximity sensor 123 signals the controller 110, and the controller 110 extinguishes the light to the screen of the display apparatus 107d and stops the scanning function of the touch sensor 107s. Turning off the light and scanning function of the touch panel 107 also reduces the emitted noise from the front part 150 of the terminal device 100. By reducing the noise from the terminal device 100, the performance of the contactless energy transfer is not degraded by this additional noise from the terminal device. The arrangement where the power receiving coil 201 is arranged in the cover 200 also has the aforementioned advantages of improving the communication sensitivity because the power receiving coil 201 is exterior to the terminal device 100 and hence is not in close proximity to the communication antenna and wireless communication circuitry arranged in the terminal device 100. Increasing the distance between the power receiving coil 201 and the communication antenna and circuitry by arranging the power receiving coil 201 in the front part 210 of the cover 200 minimizes the detrimental effects of the power receiving coil 201 on the wireless communication characteristics of the terminal device 100.

FIG. 5B shows an example of contactless energy transfer from the charging device 300 to the terminal device 100 where the cover 200 in the open state (i.e. the open state of the cover 200 is where the front part 210 of the cover 200 is not arranged on the front part 150 of the terminal device 100). Contactless energy transfer is enabled by arranging the front part 210 of the cover 200 on the charging device 300 in order that the magnetic flux generated by the charging device is efficiently coupled to the power receiving coil 201 in the front part 210 of the cover 200. In the open state, the large separation between the front part 210 of the cover 200 and the terminal device minimizes the influence of noise emitted from the display 107d on the power receiving coil 201. Moreover, the communications antenna and circuitry in the terminal device are also distantly located from the power receiving coil 201. Therefore, the aforementioned degradation of wireless communication performance is reduced, where the degradation is due to close proximity between the power receiving coil 201 and the communications antenna and circuitry. Furthermore, because the terminal device 100 can be charged while the cover 200 is in the open state, it is possible for a user to look at the screen of the display 107d of the terminal device 100 and to operate the touch panel 107 while the device is charging.

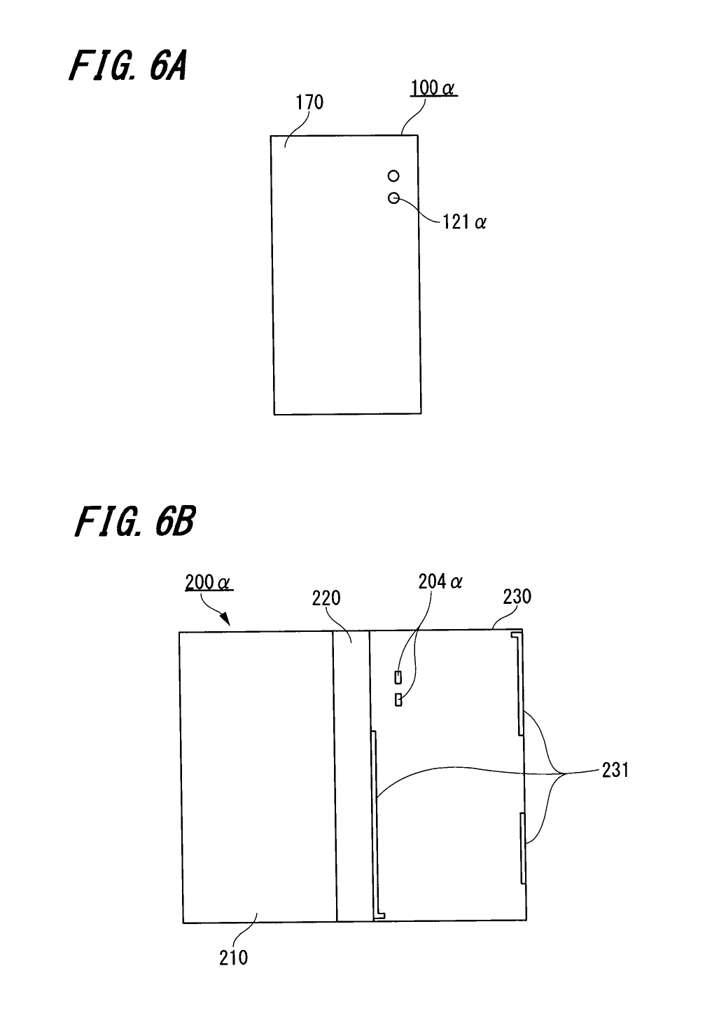

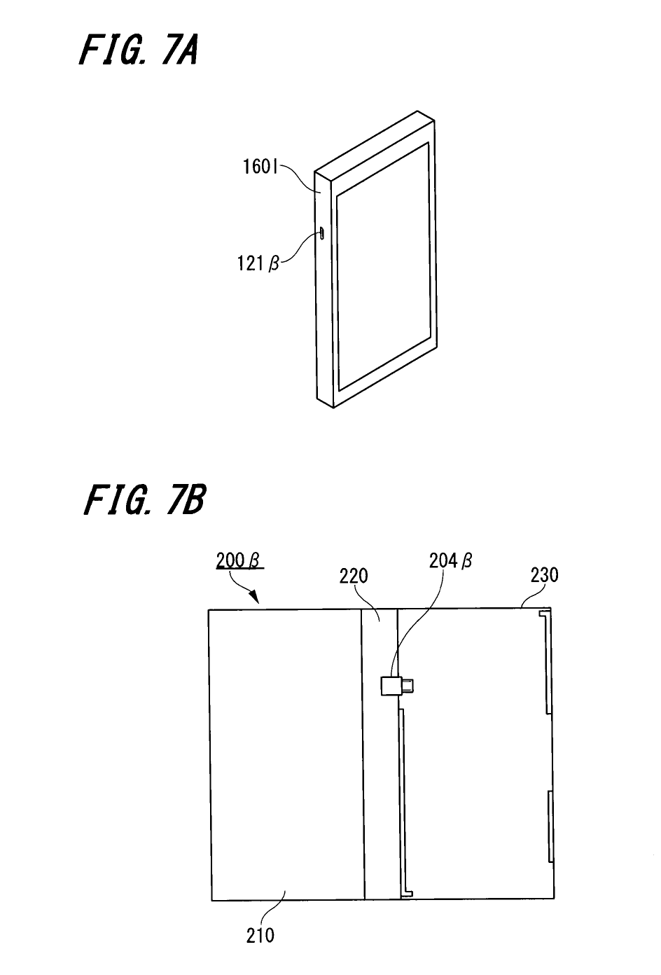

In certain embodiments, the charge terminal may be provided in the rear surface portion of the terminal device 100. FIGS. 6A and 6B show a non-limiting example of an embodiment where the charge terminal 121α is provided in the rear surface portion 170 of a terminal device 100α. FIG. 6A shows a rear view of a terminal device 100α in which a charge terminal 121α is provided on the surface of a rear surface portion 170. FIG. 6B shows a front view of a cover 200α which accommodates the terminal device 100α shown in FIG. 6A. The charge output terminal 204α is arranged in a position on the rear surface part 230 of the cover 200α corresponding to the position of the charge terminal 121α of the terminal device 100α, such that when the cover 200α accommodates the terminal device 100α favorable electrical contact is formed between the charge output terminal 204α and the charge terminal 121α.
In certain embodiments, the charge terminal of a terminal device may be a universal serial bus (USB) connector. FIGS. 7A and 7B show a non-limiting example of an embodiment where the charge terminal 121β is provided in the left-side surface portion 160l of a terminal device 100β. FIG. 7A shows a left side prospective view of the terminal device 100β in which the charge terminal 121β which is provided on the left-side surface portion 160l is a USB connector. FIG. 7B shows a front view of a cover 200β which accommodates the terminal device 100β shown in FIG. 7A. In FIG. 7B the charge output terminal 204β is a USB plug that is arranged in a position on the rear surface part 230 of the cover 200β corresponding to the position of the charge terminal 121β of the terminal device 100β, such that when the cover 200β accommodates the terminal device 100β favorable electrical contact is established between the charge output terminal 204β and the charge terminal 121β.

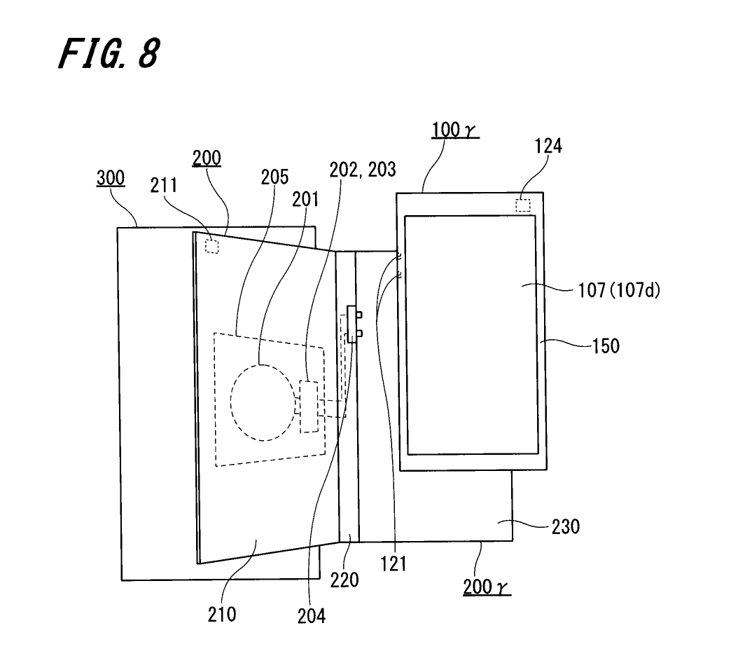

The possible embodiments of the present disclosure are not limited to embodiments in which there is a proximity sensor. In certain embodiments, a proximity sensor 123 will not be provided and a magnetic sensor 124 may be provided. FIG. 8 shows a non-limiting embodiment of a terminal device 100γ in which a magnetic sensor 124 is provided in the upper-right edge part of the front part 150. FIG. 8 also shows a cover 200γ in which a magnet 211 is arranged in a position in the front part 210 of the cover 200γ corresponding to the position of the magnetic sensor 124 in the terminal device 100. When the cover 200γ is in the closed position and the terminal device 100γ is accommodated in the cover 200γ, then the magnet 211 is in proximity to the magnetic sensor 124 and is detected by the magnetic sensor 124. When the magnet 211 is proximate to and is detected by the magnetic sensor 124, then the controller 100 of the terminal device 100γ performs control functions such as extinguishing the screen light of the display 107d. In alternative embodiments, other types of detectors rather than magnetic sensors can be used to detect when the cover 200 is in the open state or the closed state, such as illumination intensity sensors, etc.

In certain embodiments, the rear surface portion of the cover can be integral to a terminal device. Rather than having two separate and distinct parts, where one part functions as the rear surface portion of the terminal device and a second part functions as the rear surface part of the cover, there is only one part that serves both functions simultaneously. The rear surface part of the cover is integrated in to the terminal device and becomes the rear surface portion of the terminal device. Thus, the rear surface part of the cover is integral to the terminal device.

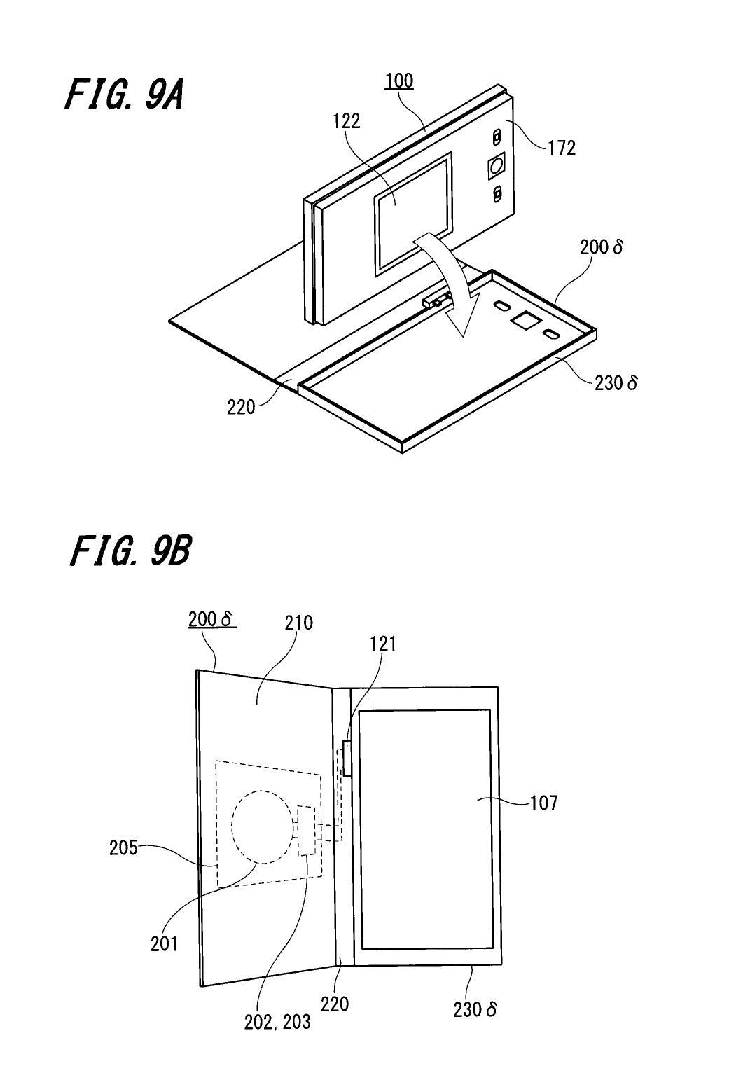

FIGS. 9A and 9B show a non-limiting example of an embodiment where there is no rear surface portion of a terminal device which is separate and distinct from the rear surface part of the cover. In this embodiment, when the rear surface part of the cover has been removed, the interior rear surface portion 172 of the terminal device 100 is exposed, and the secondary battery 122 can be seen in FIG. 9A. The conventional rear surface portion of a terminal device is replaced by the back surface portion 230δ of the cover 200δ, such that the back surface portion 230δ of the cover 200δ becomes an integral part of the terminal device 100δ and the back surface portion 230δ of the cover 200δ performs the functions of the rear surface portion of the terminal device 100δ. FIG. 9A shows a correspondence between the terminal device 100δ and the cover 200δ whereby the rear surface portion of the terminal device 100δ is removed and the back surface portion 230δ of the cover 200δ accommodates the terminal device 100δ. FIG. 9B shows the state where the terminal device 100δ is accommodated in the cover 200δ.

In certain embodiments, the contactless energy transfer from the charging device 300 to the terminal device 100 is performed by methods other than the electromagnetic induction type contactless energy transfer. In these alternative embodiments the method of contactless energy transfer may be performed using magnetic resonance type contactless energy transfer, electromagnetic wave type contactless energy transfer, etc.

In certain embodiments, the device will include at least one of the features employed to reduce the influence of noise on the power receiving coil 201 from the display 107d, where the features for reducing noise on the power receiving coil 201 include extinguishing the screen light to the display 107d when the cover 200 is in the closed position and the magnetic sheet 205 for attenuating noise emitted from the display 107d. The alternative embodiments may include extinguishing the screen light to the display 107d when the cover 200 is in the closed position but not include the feature of the magnetic sheet 205. Further, alternative embodiments may include the features of the magnetic sheet 205 to attenuate noise emitted from the display 107d but not include the feature of extinguishing the screen light to the display 107d when the cover 200 is in the closed position.

In certain embodiments, the device will include alternative designs for the charge terminal 121 of the terminal device 100 and for the charge output terminal 204 of the cover 200. Whereas USB type connectors and spring type connectors are previously disclosed, any type of shape of connector may be used so long as the connector shape enables favorable electrical contact is established between the charge terminal 121 of the terminal device 100 and the charge output terminal 204 of the cover 200. Also, whereas the previous disclosure only discussed two locations for the connectors (i.e. for the charge terminal 121 the two locations are (1) on the surface of the left-side part 160l and (2) on the surface of the rear surface portion 170, and for the charge output terminal 204 at corresponding locations on the rear surface part 230 of the cover 200), the charge terminal 121 of the terminal device 100 and the charge output terminal 204 of the cover 200 can be provided respectively to any location on the terminal device 100 and the terminal device cover 200 so long as the terminal device 100 can be accommodated in the cover 200 such that favorable electrical contact is created between the charge terminal 121 of the terminal device 100 and the charge output terminal 204 of the cover 200. For example, the charge terminal 121 of the terminal device 100 can be provided in the upper surface 160s or the bottom surface 160d of the terminal device, where the charge output terminal 204 of the cover 200 is provided to a corresponding location on the surface of the back surface portion 230 of the cover 200. Obviously, numerous modifications and variations of the present disclosure are possible in light of the above teachings. It is therefore to be understood that within the scope of the appended claims, the present disclosure may be practiced otherwise than as specifically described herein. For example, advantageous results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable processing circuits configured to execute program code and/or computer instructions to execute the functions, processes and algorithms described herein. A processing circuit includes a programmed processor, as a processor includes circuitry. A processing circuit also includes devices such as an application specific integrated circuit (ASIC) and conventional circuit components arranged to perform the recited functions.

The functions and features described herein may also be executed by various distributed components of a system. For example, one or more processors may execute these system functions, wherein the processors are distributed across multiple components communicating in a network. The distributed components may include one or more client and/or server machines, in addition to various human interface and/or communication devices (e.g., display monitors, smart phones, tablets, personal digital assistants (PDAs)). The network may be a private network, such as a LAN or WAN, or may be a public network, such as the Internet. Input to the system may be received via direct user input and/or received remotely either in real-time or as a batch process. Additionally, some implementations may be performed on modules or hardware not identical to those described. Accordingly, other implementations are within the scope that may be claimed.

It must be noted that, as used in the specification and the appended claims, the singular forms “a,” “an,” and “the” include plural referents unless the context clearly dictates otherwise.

The above disclosure also encompasses the embodiments noted below.

(1) A terminal device cover comprising: a front surface part arranged in a position to cover a front surface of a terminal device; a lateral surface part which is formed continuously from the front surface part and which is arranged in a position to cover a lateral surface of the terminal device; a rear surface part which is formed continuously from the lateral surface part and which is arranged in a position to come into contact with a rear surface of the terminal device; a power receiving circuit arranged in the front surface part, and configured to receive electrical power transmitted from a non-contact power transmission device; a rectifier circuit arranged in the front surface part, and configured to rectify the electrical power received by the power receiving circuit; and a charging output terminal configured to connect to a charging terminal of the terminal device to thereby output the electrical power rectified by the rectifier circuit to the charging terminal of the terminal device.

(2) The cover according to (1), further comprising a control circuit arranged in the front surface part, wherein the control circuit is configured to control the rectified electrical power from the rectifier circuit.

(3) The cover according to (1) or (2), further comprising a magnetic sheet arranged in the front surface part of the terminal device cover, wherein the magnetic sheet covers the power receiving circuit.

(4) The cover according to any one of (1) to (3), further comprising a magnetic sheet arranged in the front surface part of the terminal device cover, wherein the magnetic sheet covers the power receiving circuit.

(5) The cover according to any one of (1) to (4), wherein the magnetic sheet further covers the rectifier circuit and the control circuit.

(6) The cover according to any one of (1) to (5), further comprising a terminal device fixing wall arranged in the rear surface part and configured to fix the terminal device to a predetermined position in the rear surface part.

(7) The cover according to any one of (1) to (6), wherein the charging output terminal is a universal serial bus (USB) plug.

(8) The cover according to any one of (1) to (7), wherein the charging output terminal is a spring type connector.

(9) The cover according to any one of (1) to (8), wherein the power receiving circuit is further configured to receive electrical power transmitted via electromagnetic induction type contactless energy transfer from the non-contact power transmission device.

(10) The cover according to any one of (1) to (9), further comprising a magnet arranged in the front surface part, and configured to generate a control when the terminal device cover is in a closed position.
(11) A terminal comprising: a cover configured to house the terminal device, wherein the cover includes a front surface part, a lateral surface part, and a rear surface part. The cover includes a power receiving circuit configured to receive electrical power transmitted from a non-contact power transmission device and arranged in the front surface part; a display arranged in a position covered by the front surface part of the cover; a detector arranged on the same surface where the display is arranged, and configured to detect proximity or contact of an object with the front surface part of the cover; and a controller configured to turn off the display when the detector detects the proximity or the contact of an object with the first surface of the terminal device.

a power receiving circuit arranged in the front surface portion thereof, and the power receiving circuit is configured to receive electrical power transmitted from a non-contact power transmission device; a display arranged in a position covered by the front surface portion of the cover; a detector arranged on the same surface where the display is arranged, and configured to detect proximity or contact of an object with the front surface portion of the cover; a controller configured to turn off the display when the detector detects the proximity or the contact of an object with the first surface of the terminal device.

(12) The terminal device according to (11), wherein the detector is an illumination intensity sensor.

(13) The terminal device according to (11), wherein the detector is a proximity sensor.

(14) The terminal device according to (11), wherein the detector is a magnetic sensor.

(15) The terminal device according to any one of (11) to (14), wherein the cover is integrally connected to the terminal device such that the rear surface part of the cover is the rear surface portion of the terminal device.

(16) The cover according to one of (11) to (15), further comprising: a control circuit arranged in the front surface part; and a rectifier circuit arranged in the front surface part, and configured to rectify the electrical power received by the power receiving circuit, wherein the control circuit is configured to control the rectified electrical power from the rectifier circuit.

(17) The cover according to one of (11) to (16), further comprising a magnetic sheet arranged in the front surface part of the terminal device cover, wherein the magnetic sheet covers the power receiving circuit.

(18) A cover apparatus comprising: a front surface part arranged in a position to cover a front surface of a terminal device; a lateral surface part which is formed continuously from the front surface part and which is arranged in a position to cover a lateral surface of the terminal device; a rear surface part which is formed continuously from the lateral surface part and which is arranged in a position to come into contact with a rear surface of the terminal device; receiving means for receiving electrical power transmitted from a non-contact power transmission device, wherein the receiving means is arranged in the front surface part of the cover; rectifying means for rectifying the electrical power received by the power receiving circuit, wherein the rectifying means is arranged in the front surface part of the cover; and electrical connection means for electrically connecting to a charging terminal of the terminal device to thereby provide rectified electrical power to the charging terminal of the terminal device, wherein the electrical connection means is arranged in the front surface part of the cover.

(19) The cover according to (18), further comprising: controller means for controlling the rectified electrical power from the rectifying means, wherein the controller means is arranged in the front surface part of the cover.

(20) The cover according to one of (18) and (19), further comprising: a magnetic sheet arranged in the front surface part, wherein the magnetic sheet covers the receiving means.

1. A cover apparatus comprising:
a front surface part arranged in a position to cover a front surface of a terminal device;
a lateral surface part which is formed continuously from the front surface part and which is arranged in a position to cover a lateral surface of the terminal device;
a rear surface part which is formed continuously from the lateral surface part and which is arranged in a position to come into contact with a rear surface of the terminal device;
a power receiving circuit arranged in the front surface part, and configured to receive electrical power transmitted from a non-contact power transmission device;
a rectifier circuit arranged in the front surface part, and configured to rectify the electrical power received by the power receiving circuit; and
a charging output terminal configured to connect to a charging terminal of the terminal device to thereby output the electrical power rectified by the rectifier circuit to the charging terminal of the terminal device.

2. The cover apparatus according to claim 1, further comprising:
a control circuit arranged in the front surface part, wherein
the control circuit is configured to control the rectified electrical power from the rectifier circuit.

3. The cover apparatus according to claim 1, further comprising:
a magnetic sheet arranged in the front surface part, wherein the magnetic sheet covers the power receiving circuit.

4. The cover apparatus according to claim 2, further comprising:
a magnetic sheet arranged in the front surface part, wherein the magnetic sheet covers the power receiving circuit.

5. The cover apparatus according to claim 4, wherein
the magnetic sheet further covers the rectifier circuit and the control circuit.

6. The cover apparatus according to claim 1, further comprising:
a terminal device fixing wall arranged in the rear surface part and configured to fix the terminal device to a predetermined position in the rear surface part.

7. The cover apparatus according to claim 1, wherein
the charging output terminal is a universal serial bus (USB) plug.

8. The cover apparatus according to claim 1, wherein
the charging output terminal is a spring type connector.

9. The cover apparatus according to claim 1, wherein
the power receiving circuit is further configured to receive electrical power transmitted via electromagnetic induction type contactless energy transfer from the non-contact power transmission device.

10. The cover apparatus according to claim 1, further comprising
a magnet arranged in the front surface part, and configured to generate a control when the terminal device cover is in a closed position.

11. A terminal device comprising:
a cover configured to house the terminal device, wherein the cover includes
a front surface part;
a lateral surface part;
a rear surface part; and
a power receiving circuit configured to receive electrical power transmitted from a non-contact power transmission device and arranged in the front surface part;
a display arranged in a position covered by the front surface part of the cover;
a detector arranged on the same surface where the display is arranged, and configured to detect proximity or contact of an object with the front surface part of the cover; and
a controller configured to turn off the display when the detector detects the proximity or the contact of an object with the first surface of the terminal device.

12. The terminal device according to claim 11, wherein
the detector is an illumination intensity sensor.

13. The terminal device according to claim 11, wherein
the detector is a proximity sensor.

14. The terminal device according to claim 11, wherein
the detector is a magnetic sensor.

15. The terminal device according to claim 11, wherein
the cover is integrally connected to the terminal device such that the rear surface part of the cover is a rear surface portion of the terminal device.

16. The cover according to claim 15, further comprising:
a control circuit arranged in the front surface part; and
a rectifier circuit arranged in the front surface part, and configured to rectify the electrical power received by the power receiving circuit, wherein
the control circuit is configured to control the rectified electrical power from the rectifier circuit.

17. The cover according to claim 15, further comprising
a magnetic sheet arranged in the front surface part of the cover, wherein
the magnetic sheet covers the power receiving circuit.

18. A cover apparatus comprising:
a front surface part arranged in a position to cover a front surface of a terminal device;
a lateral surface part which is formed continuously from the front surface part and which is arranged in a position to cover a lateral surface of the terminal device;
a rear surface part which is formed continuously from the lateral surface part and which is arranged in a position to come into contact with a rear surface of the terminal device;
receiving means for receiving electrical power transmitted from a non-contact power transmission device, wherein the receiving means is arranged in the front surface part of the cover;
rectifying means for rectifying the electrical power received by the power receiving circuit, wherein the rectifying means is arranged in the front surface part of the cover; and
electrical connection means for electrically connecting to a charging terminal of the terminal device to thereby provide rectified electrical power to the charging terminal of the terminal device, wherein the electrical connection means is arranged in the front surface part of the cover.

19. The cover apparatus according to claim 18, further comprising:
controller means for controlling the rectified electrical power from the rectifying means, wherein the controller means is arranged in the front surface part of the cover.

20. The cover apparatus according to claim 18, further comprising:
a magnetic sheet arranged in the front surface part, wherein the magnetic sheet covers the receiving means.
